(19) United States
(12) Patent Application Publication
(10) Pub. No.: US 2009/0320318 A1
(43) Pub. Date: Dec. 31, 2009

(54) Operating method for laundry machine

(76) Inventors: Pyoung Hwan Kim, Gyeongsangnam-do (KR); Su Hee Shin, Gyeongsangnam-do (KR); Seong Hae Jeong, Gyeongsangnam-do (KR); Young Soo Kim, Gyeongsangnam-do (KR); Deug Hee Lee, Gyeongsangnam-do (KR)

Correspondence Address: MCKENNA LONG & ALDRIDGE LLP, 1900 K STREET, NW, WASHINGTON, DC, 20006, US

(21) Appl. No.: 12/310,794

(22) PCT Filed: Sep. 6, 2007
(86) PCT No.: PCT/KR2007/004315

§ 371 Date: Mar. 6, 2009

(30) Foreign Application Priority Data
Sep. 8, 2006 (KR) 10-2006-0086848

(51) Int. Cl. F26B 7/00; F26B 3/02

(52) U.S. Cl. 34/428; 34/499

(57) ABSTRACT

An operating method for a laundry machine capable of efficiently removing dust and start smell from clothes without using washing water and efficiently removing wrinkles from clothes in a convenient manner is disclosed. The operating method for a laundry machine which includes a tub (200) for storing washing water, a drum (300) for acommodating laundry, a steam generator (400) that is supplied with water for generating steam separately from the washing water to supply steam to the laundry and an air supply device (600) for compulsorily supplying air into the drum (300), the operating method including supplying hot air into the drum (300) to increase a temperature of the laundry and an innen temperature of the drum (300) and remove dust or volatile smell particles contained in the laundry, supplying steam into the drum (300) to dissolve non-volatile smell particles and relieve wrinkles of the laundry, and resupplying hot air into the drum (300) to remove moisture and wrinkles from the laundry.

### TECHNICAL FIELD

The present invention relates to an operating method for a laundry machine, and more particularly to a laundry machine capable of efficiently removing dust and smell from clothes without using washing water and efficiently removing wrinkles from clothes in a convenient manner.

### BACKGROUND ART

Generally, laundry machines are classified into a pulsator-type laundry machine having a vertically-provided drum, a drum-type laundry machine having a horizontally-provided drum, a laundry machine also serving as a dryer having a drying function and a clothes dryer for only drying clothes and the like.

Generally, the laundry machine also serving as a dryer and the clothes dryer are operated such that high-temperature hot air is supplied into a drum to dry wet clothes and the like.

However, the laundry machine also serving as a dryer and the clothes dryer according to prior art do not have a separate structure or perform a separate operation for removing the wrinkles although a lot of wrinkles are generated in dried clothes by the operation thereof. Particularly, the laundry machine also serving as a dryer and the clothes dryer according to prior art do not perform removal of wrinkles on the clothes in a dry state. Accordingly, the user should inconveniently perform a separate operation of ironing the clothes in a dry state to wear the clothes.

Meanwhile, in a conventional laundry machine or dryer also serving as a washer, a washing operation should be performed using washing water to remove dust or smell of the clothes. Accordingly, there are problems such that time and energy are wasted and a life span of the clothes is reduced due to unnecessary washing. Further, in case of a dryer, it is impossible to remove dust or smell from the clothes or wrinkles.

### DISCLOSURE OF INVENTION

### Technical Problem

An object of the present invention devised to solve the problem lies on an operating method for a laundry machine capable of efficiently removing dust or smell from laundry without using washing water.

Further, another object of the present invention is to provide an operating method for a laundry machine capable of removing wrinkles from target objects which require removal of wrinkles or efficiently reducing wrinkles without using washing water.

Further, yet another object of the present invention is to provide an operating method for a laundry machine capable of putting the clothes in which wrinkles, dust and smell have been removed in a pleasant state wherein a user can wear immediately.

### Technical Solution

The objects of the present invention can be achieved by providing an operating method for a laundry machine which includes a tub for storing washing water, a drum for accommodating laundry, a steam generator that is supplied with water for generating steam separately from the washing water to supply steam to the laundry and an air supply device for compulsorily supplying air into the drum, the operating method comprising: supplying hot air into the drum to increase a temperature of the laundry and an inner temperature of the drum and remove dust or volatile smell particles contained in the laundry; supplying steam into the drum to dissolve non-volatile smell particles and relieve wrinkles of the laundry; and resupplying hot air into the drum to remove moisture and wrinkles from the laundry.

The drum may be operated at at least one step of the steps of supplying hot air, supplying steam and resupplying hot air. That is, hot air or steam is supplied uniformly to the laundry due to the operation of the drum.

The drum may be repeatedly rotated forward and backward.

The drum may be tumbled at the step of supplying hot air such that the laundry is repeatedly lifted and dropped in the drum. Accordingly, it provides an effect of shaking the laundry to efficiently remove dust from the laundry.

The hot air may be periodically or intermittently supplied at the step of supplying hot air. Accordingly, the laundry can be efficiently shaken compared to continuous supply of hot air.

Further, the operating method may further include supplying old air into the drum. The drum may be continuously rotated to prevent wrinkles of the laundry from being generated at the step of supplying cold air. Also, at the step of supplying cold air, cold air may be supplied for a specified period of time and only the drum may be rotated until a specified period of time has passed after the supply of old air is stopped.

In the above operating method, when any one of a number of operation courses is selected, the laundry machine may be operated according to the selected operation course.

The objects of the present invention can be achieved by providing an operating method for a laundry machine which includes a drum for accommodating laundry, a driving unit for rotating the drum, a steam generator that is supplied with water for generating steam to supply steam to the laundry, an air supply device for compulsorily supplying air into the drum and a controller for controlling the driving unit and the air supply device, the operating method comprising: supplying hot air to the laundry accommodated in the drum; supplying steam to the laundry accommodated in the drum; and resupplying hot air to the laundry accommodated in the drum.

The objects of the present invention can be achieved by providing an operating method for a laundry machine which includes a drum for accommodating laundry, a moisture supply device that is supplied with water to supply moisture to the laundry and an air supply device for compulsorily supplying air into the drum, the operating method comprising: supplying hot air into the drum to increase a temperature of the laundry and an inner temperature of the drum and remove dust or volatile smell particles contained in the laundry; supplying moisture into the drum to dissolve non-volatile smell particles and relieve wrinkles of the laundry; and resupplying hot air into the drum to remove moisture and wrinkles from the laundry.

In this case, moisture may be supplied into the drum in a mist form. Further, the mist may be sprayed into the drum. The supply of mist may be performed with the supply of hot air.

### Advantageous Effects

As described above, according to the present invention, it is possible to provide a laundry machine capable of efficiently removing dust, wrinkles and smell.

Further, according to the present invention, it is possible to provide a laundry machine capable of removing wrinkles, smell or the like without using washing water, thereby saving washing water and washing time.

Further, it is possible to provide a laundry machine capable of preventing damage of clothes due to excessive washing, and capable of removing moisture and reviving the texture and strands of clothes by supplying steam, hot air or cold air to put the clothes in a pleasant state.

Further, according to the present invention, it is possible to provide a laundry machine with convenient use and control, capable of performing removal of dust, wrinkles and smell at once as the user selects one operation course.

Meanwhile, since the operating method according to the present invention can be applied to a dryer, it is possible to enhance efficiency of the dryer which performs only a drying operation.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 illustrates a side cross-sectional view for explaining an inner structure of a laundry machine according to the present invention.

FIG. 2 illustrates a plan view for explaining the inner structure of the laundry machine according to the present invention.

FIG. 3 illustrates a flowchart for explaining an operating method for a wrinkle removal course of the laundry machine according to the present invention.

### BEST MODE FOR CARRYING OUT THE INVENTION

Reference will now be made in detail to the preferred embodiments of the present invention, examples of which are illustrated in the accompanying drawings.

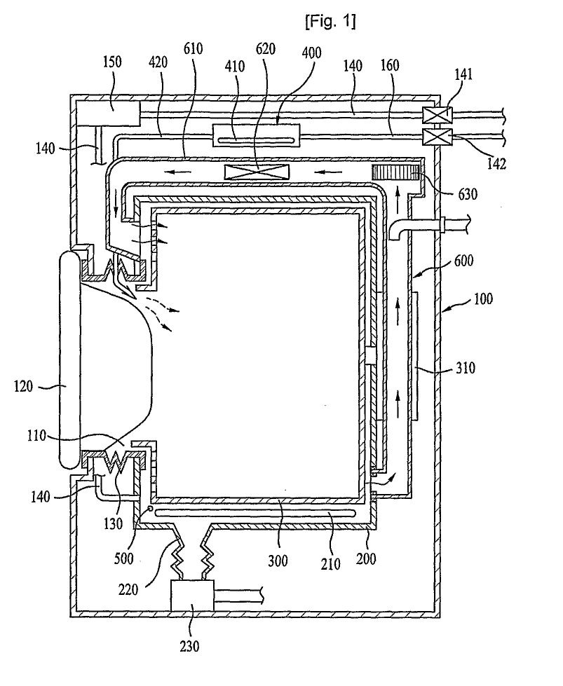

Hereinafter, a laundry machine and an operating method for the laundry machine according to the present invention will be described in detail with reference to FIGS. 1 to 3.

The laundry machine according to the present invention also serves as a dryer. Further, the laundry machine may be a clothes dryer.

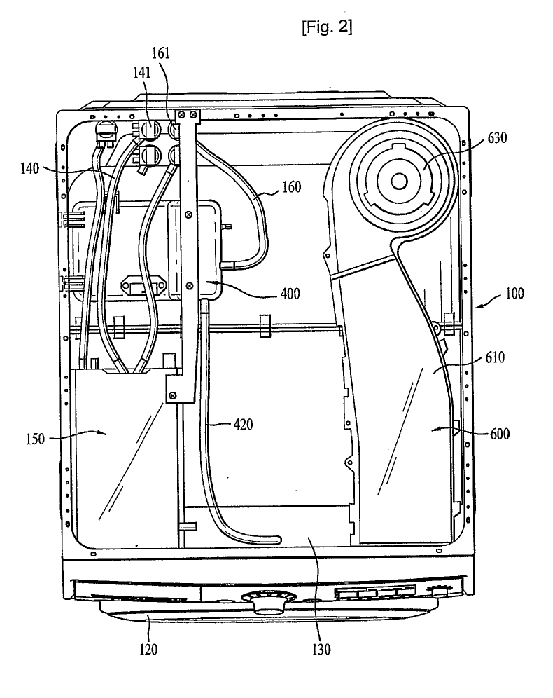

First, as shown in FIGS. 1 and 2, the laundry machine according to one embodiment of the present invention includes a main body 100, a tub 200, a drum 300, a steam generator 400, a temperature sensor 500 and an air supply device 600. In this case, the steam generator may be replaced by a moisture supply device as will be described later. Specifically, the moisture supply device may be a device for supplying moisture in a mist form.

The main body 100 forms an external appearance of the laundry machine. A loading opening 110 is disposed on a front surface of the main body 100.

A door 120 for opening and closing the loading opening 110 is mounted on the loading opening 110 of the main body 100. A gasket 130 for sealing between the door 120 and the loading opening 110 is mounted on an inner peripheral surface of the loading opening 110.

Further, a washing water supply line 140 is provided in the main body 100 to supply washing water into the tub 200.

In this case, a detergent box 150 is disposed at the main body 100. The washing water supply line 140 is connected to the inside of the tub 200 after passing through the detergent box 150.

Further, the tub 200 is provided to be supported in the main body 100.

A heater 210 for washing water, which heats the washing water supplied into the tub 200, is disposed at a lower end portion of the tub 200.

Further, a drain channel 220 for draining the washing water is disposed at the lower end of the tub 200.

A drain pump 230 which is driven to compulsorily drain the washing water is disposed on the drain channel 220.

Further, the drum 300 is rotatably installed in the tub 200. The drum 300 is mounted such that an opening of the drum 300 is positioned toward the loading opening 110 of the main body 100.

A driving unit 310 for rotating the drum 300 is coupled to the rear of the drum 300.

Further, the steam generator 400 is configured to provide a specified amount of steam into the drum 300 Or tub) and at least one steam generator is disposed. FIG. 2 illustrates a plan view showing a mounting example of the steam generator 400.

The steam generator 400 includes a heating unit 410 which heats the water stored in the steam generator 400 to generate steam and a steam supply line 420 which guides the flow of the generated steam.

Preferably, the steam discharge side of the steam supply line 420 is installed toward the inside of the drum 300 to pass through the gasket 130.

The temperature sensor 500 serves to sense the inner temperature of the tub 200. Preferably, the temperature sensor 500 is disposed in a space inside the tub 200.

In this case, the temperature sensed by the temperature sensor 500 may be used to control the operation of the steam generator 400 and the operation of the air supply device 600.

The air supply device 600 is used to dry the clothes and is configured to provide high-temperature hot air or cold air into the drum 300.

The air supply device 600 is configured to include an air duct 610, a drying heater 620, a blowing fan 630 and a fan motor (not shown).

The air duct 610 is installed such that the opposite ends of the air duct 610 communicate with the inside of the tub 200. Preferably, one end of the air duct 610 is connected to the rear side of the tub 200 and the other end of the air duct 610 is connected to the front side of the tub 200. Further, it is possible that one end of the air duct 610 is installed to communicate with the tub 200 and the other end of the air duct 610 is installed to communicate with the outside of the main body 100.

The drying heater 620 is disposed in the air duct 610 and is configured to heat air flowing in the air duct 610 to generate hot air.

Further, the blowing fan 630 and the fan motor are disposed in the air duct 610 and configured such that the air in the air duct 610 passes through the drying heater 620 to be supplied into the drum 300.

Meanwhile, a reference numeral 160 is a steam water supply line which supplies water into the steam generator 400. Accordingly, the water supplied into the steam generator is distinguished from the washing water in the laundry machine according to the present invention. Thus, the washing water including a detergent is not supplied into the steam generator. Further, the steam generator is disposed separately from the tub 200.

Further, reference numerals 141 and 161 are opening/closing valves which open and close paths of the washing water supply line 140 and the steam water supply line 160, respectively.

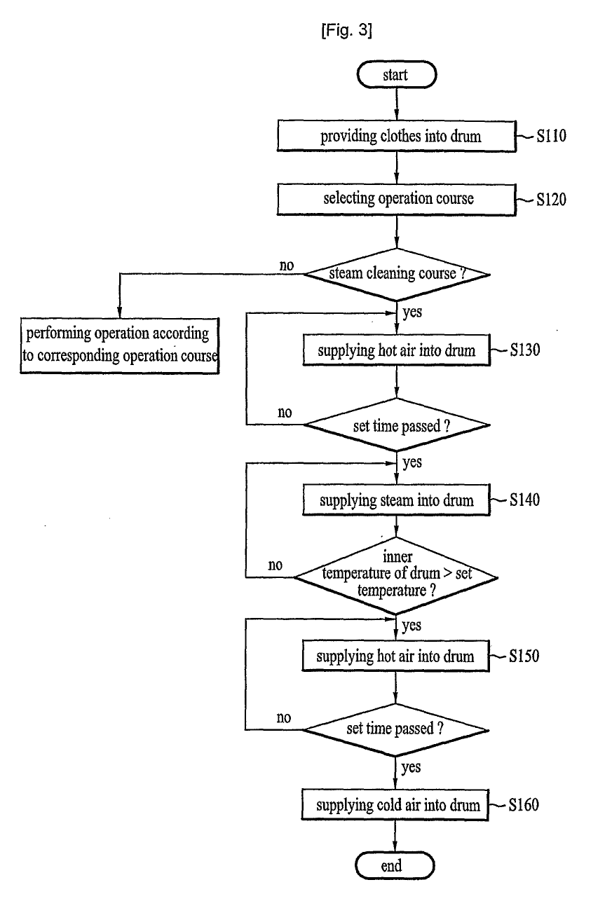

The operating method for the laundry machine having the above-described configuration according to the embodiment of the present invention will be described with reference to a flowchart shown in FIG. 3.

First, the laundry which requires removal of dust, smell and wrinkles is provided into the drum (S110). Further, a user selects an operation course for removing smell or wrinkles (hereinafter, referred to as a “steam cleaning course”) among a number of operation courses (S120). Thus, if the user selects the steam cleaning course, the laundry machine is operated by an operating method corresponding to the steam cleaning course. If the user selects another operation course, the laundry machine is operated by an operating method corresponding to the selected operation course.

The laundry is mainly laundry which has not been washed. Preferably, the laundry is in a dry state or contains only a small amount of water. The laundry may be water-extracted laundry which contains a small amount of water and requires removal of wrinkles.

Then, a controller (not shown) controls the operation of the air supply device to supply hot air to the laundry in the drum (S130). Further, the controller controls the drum driving unit to rotate the drum.

The hot air may be continuously supplied into the drum for a set period of time. Meanwhile, preferably, the drum is operated to supply hot air uniformly to the laundry while supplying hot air. That is, it is possible to supply hot air uniformly to the laundry by repeatedly lifting and dropping the laundry. The hot air may be repeatedly supplied as the drum is operated.

The hot air is supplied to remove dust from the laundry. Accordingly, it is necessary to shake the laundry to efficiently remove dust from the laundry. For this, it is preferable to tumble the drum since it makes the laundry to be shaken while the laundry drops.

Further, preferably, the hot air is periodically or intermittently supplied. That is, it is possible to shake the laundry by periodically or intermittently applying a physical impact on the laundry through the hot air.

The operation of the drum and the air supply device for supplying the hot air may be controlled by the controller.

Further, volatile smell particles contained in the laundry are removed primarily by supplying the hot air. If the hot air is supplied in a condensation manner, the volatile smell particles are discharged to the outside of the laundry machine with condensed water. If the hot air is supplied in an exhausting manner, the volatile smell particles are directly discharged to the outside of the laundry machine.

Meanwhile, when laundry containing a small amount of water is provided into the drum, it is possible to obtain an effect of relieving or removing wrinkles due to the hot air supply. Further, when dry laundry is provided into the drum, the temperature of the drum, the tub and the laundry increases as the hot air is supplied, thereby forming optimal conditions under which steam supplied in the following steam supplying step can infiltrate into the laundry. That is, it is possible to obtain an effect of preheating the laundry.

Further, the drum is operated at the hot air supplying step S130. Accordingly, the hot air is supplied by repeatedly lifting and dropping the laundry, thereby separating dust particles and the like contained in the laundry from the laundry. Thus, it is possible to easily remove dust containing various bacteria and the like.

If the hot air supplying step S130 is completed, the steam is supplied into the drum (S140). The supply of the steam may be performed by spraying the steam. It is possible to obtain an effect of supplying the steam uniformly to the laundry by spraying the steam. Also, it is preferable to operate the drum at this step.

At the steam supplying step S140, it is possible to remove non-volatile smell particles which have not been removed in the above-mentioned hot air supplying step S130. That is, the steam is supplied to the laundry, particularly, the non-volatile smell particles contained in the laundry to dissolve the smell particles. Accordingly, it provides a state capable of easily removing the non-volatile smell particles.

Meanwhile, the steam infiltrates deep into the laundry to relieve or remove the wrinkles from the laundry. That is, the steam infiltrates between finely interlaced wrinkles to relieve or remove the wrinkles from the laundry.

Preferably, it is controlled such that an excessive amount of steam is not supplied in the steam supplying step S140. That is, since the excessive amount of steam is converted into water as the temperature decreases to get the laundry wet, a lot of time and energy for redrying may be consumed. Accordingly, the supply amount of the steam should be controlled appropriately.

For example, the supply amount of the steam is controlled by checking an increase in the temperature of the drum or the tub due to the steam. That is, since an excessive increase in the temperature means an excessive supply amount of the steam, it is possible to control the supply amount of the steam by checking an increase in the temperature. Also, it is possible to control the supply amount of the steam by checking a spraying time of the continuously sprayed steam. That is, it is possible to appropriately control the supply amount of the steam by setting a steam spraying time based on the amount of the sprayed steam per time period.

If the steam supplying step S140 is completed, it is preferable to supply the hot air into the drum again. That is, preferably, a hot air drying step S150 is performed to resupply the hot air.

The non-volatile smell particles dissolved due to the steam at the steam supplying step S140 can be evaporated to be removed by resupplying the hot air. Also, the volatile smell particles which have not been removed at the previous steps can be removed.

Also at the hot air drying step S150, preferably, the drum is operated such that the hot air is supplied uniformly to the laundry. It is possible to remove moisture or smell particles from the inside of the drum or the tub as well as the laundry at the hot air drying step. In this case, the operation of the drum includes repeated forward and backward rotation, tumbling and the like.

Meanwhile, in the aspect of removing the wrinkles, the wrinkles relieved due to the steam supply can be surely removed by resupplying the hot air. Further, it may be controlled such that the hot air drying step is performed for a set period of time.

If the hot air drying step S150 is completed, it is preferable to perform a old air supplying step S160 for supplying cold air into the drum for the following reasons. Since the temperature of the drum, the tub and the laundry increases at the hot air drying step, the user may get burnt when the user opens the door. Further, when the temperature of the laundry is high, the user cannot wear the laundry until the temperature of the laundry becomes decreased.

Meanwhile, smell particles, dust and the like which have not removed yet can be surely removed by supplying the old air. Further, the laundry can be completely dried by the cold air such that the laundry becomes clothes in a pleasant state by reviving the texture and strands of the laundry. Also, it is possible to more surely remove the wrinkles.

At the cold air supplying step S160, the wrinkles of the laundry have been removed and it is necessary to prevent the wrinkles from being generated due to the weight of the laundry. Accordingly, preferably, it is controlled such that the drum is continuously rotated at this step.

Further, it may be controlled such that the cold air supplying step is performed for a specified period of time. As described above, when this step is completed, although the supply of the old air is stopped, preferably, it is controlled such that the drum is continuously rotated to prevent the wrinkles from being generated before the user opens the door or until a specified period of time has passed after the supply of the cold air is stopped.

Further, as described above, in the operating method for the laundry machine according to the present invention, preferably, it is controlled such that all steps are automatically performed when the user selects one operation course. Accordingly, since the above-described operation of the laundry machine is performed although the user selects one operation course, the use and control become convenient.

Meanwhile, although the steam is used to apply moisture to the laundry in the above-described embodiment, it is possible to supply non-heated moisture to the laundry instead of the steam. That is, the steam generator may be replaced by a moisture generator.

Preferably, the moisture is supplied in a mist form and the mist means very fine water particles. In the present invention, the supply of the moisture is performed not to soak the laundry, but to allow the laundry to have a specified percentage of water content, for example, a percentage of ten or less. Accordingly, preferably, a moisture supplying time is controlled to prevent an excessive amount of moisture from being supplied to the laundry. That is, preferably, it is controlled such that the moisture is supplied into the drum only for a set period of time.

Further, preferably, the mist is sprayed into the drum to be supplied uniformly to the laundry.

More preferably, the supply of the mist is performed together with the supply of the hot air because the non-volatile smell particles can be easily dissolved by high-temperature mist rather than room-temperature mist. Further, the high-temperature mist easily infiltrates into the laundry.

If the supply of the mist is completed, preferably, the hot air drying step and the Cold air supplying step are preformed.

### INDUSTRIAL APPLICABILITY

Included in the detailed description of the invention.

1. An operating method for a laundry machine which includes a tub for storing washing water, a drum for accommodating laundry, a steam generator that is supplied with water for generating steam separately from the washing water to supply steam to the laundry and an air supply device for compulsorily supplying air into the drum, the operating method comprising:
supplying hot air into the drum to increase a temperature of the laundry and an inner temperature of the drum and remove dust or volatile smell particles contained in the laundry;
supplying steam into the drum to dissolve non-volatile smell particles and relieve wrinkles of the laundry; and
resupplying hot air into the drum to remove moisture and wrinkles from the laundry.

2. The operating method according to claim 1, wherein the drum is operated at at least one step of the steps of supplying hot air, supplying steam and resupplying hot air.

3. The operating method according to claim 2, wherein the drum is repeatedly rotated forward and backward.

4. The operating method according to claim 1, wherein the drum is tumbled at the step of supplying hot air.

5. The operating method according to claim 1, wherein the hot air is periodically or intermittently supplied at the step of supplying hot air.

6. The operating method according to claim 1, further comprising supplying cold air into the drum.

7. The operating method according to claim 6, wherein the drum is continuously rotated to prevent wrinkles of the laundry from being generated at the step of supplying cold air.

8. The operating method according to claim 6, wherein at the step of supplying cold air, cold air is supplied for a specified period of time and the drum is continuously rotated until a specified period of time has passed after the supply of cold air is stopped.

9. The operating method according to claim 1, wherein when any one of a number of operation courses is selected, the laundry machine is operated according to the selected operation course.

10. An operating method for a laundry machine which includes a drum for acommodating laundry, a driving unit for rotating the drum, a steam generator that is supplied with water for generating steam to supply steam to the laundry, an air supply device for compulsorily supplying air into the drum and a controller for controlling the driving unit and the air supply device, the operating method comprising:
supplying hot air to the laundry accommodated in the drum;
supplying steam to the laundry accommodated in the drum; and
resupplying hot air to the laundry accommodated in the drum.

11. The operating method according to claim 10, further comprising supplying cold air to the laundry accommodated in the drum after the step of resupplying hot air.

12. The operating method according to claim 10, wherein the controller controls the driving unit such that the drum is tumbled at the step of supplying hot air.

13. The operating method according to claim 12, wherein the controller controls the air supply device such that the hot air is periodically or intermittently supplied at the step of supplying hot air.

14. The operating method according to claim 10, wherein when any one of a number of operation courses is selected, the laundry machine is operated according to the selected operation course.

15. An operating method for a laundry machine which includes a drum for accommodating laundry, a moisture supply device that is supplied with water to supply moisture to the laundry and an air supply device for compulsorily supplying air into the drum, the operating method comprising:
supplying hot air into the drum to increase a temperature of the laundry and an inner temperature of the drum and remove dust or volatile smell particles contained in the laundry;
supplying moisture into the drum to dissolve non-volatile smell particles and relieve wrinkles of the laundry; and
resupplying hot air into the drum to remove moisture and wrinkles from the laundry.

16. The operating method according to claim 15, further comprising supplying cold air into the drum after the step of resupplying hot air.

17. The operating method according to claim 15, wherein the drum is tumbled at the step of supplying hot air.

18. The operating method according to claim 15, wherein hot air is supplied into the drum at the step of supplying moisture.

19. The operating method according to claim 15, wherein moisture is supplied into the drum in a mist form at the step of supplying moisture.

20. The operating method according to claim 15, wherein the hot air is periodically or intermittently supplied at the step of supplying hot air.
